(19) United States
(12) Patent Application Publication
(10) Pub. No.: US 2003/0168879 A1
(43) Pub. Date: Sep. 11, 2003

(54) Ladder rack cover

(76) Inventor: Mike Grudek, Leucadia, CA (US)

Correspondence Address: US CORPORATIONS, INC., 630 NEPTUNE AVE., ENCINITAS, CA, 92024, US

(21) Appl. No.: 10/379,225

(22) Filed: Mar. 4, 2003

Related U.S. Application Data
(60) Provisional application No. 60/361,394, filed on Mar. 5, 2002.

(51) Int. Cl. B60P 7/02; B65D 65/02; B65D 85/00; B60R 9/00; B60R 9/055; B60R 7/00

(52) U.S. Cl. 296/100.15; 224/405; 224/328; 150/166; 296/100.01; 296/100.16

(57) ABSTRACT

A ladder rack cover designed for the pick up truck and four post utility ladder rack mounted on the walls or bed of the truck which is fabric based, attached to the ladder rack and bed of the pick up truck creating a weather resistant shell for the protection of goods in the bed or on the ladder rack.

### CROSS-REFERENCE TO RELATED APPLICATION

This application relies on a previously filed provisional application 60/361,394 filed on Mar. 5, 2002.

### STATEMENT REGARDING FEDERALLY SPONSORED RESEARCH OR DEVELOPMENT

Not applicable

### REFERENCE TO SEQUENCE LISTING

Not applicable

### BACKGROUND

The ladder rack was created 30 to 40 years ago. It was created to maximize the hauling capabilities of pick up trucks. Pick up trucks have limits on the length of items that can safely be carried in the bed of the truck. A ladder rack allows the truck to carry long items (ladders, lumber, pipe, etc.) safely above the bed and cab of the truck while allowing the bed of the pick up truck to be free to carry other smaller items.

Pick up truck bed covers have been around in different forms since the pick up truck was created. Truck bed covers have evolved from the simplest tarp laid over the truck bed and contents to truck bed shells which use fiberglass to enclose the bed of the truck. People have created different truck bed covers for individual needs. The function and capabilities of these covers vary from one to the other. Truck bed covers are built for protection from weather, theft, camping, etc. The array of truck bed covers that now exist are classified as the fiberglass/hard shell, fabric convertible shell, hard and soft Tonneau covers, truck bed tents, and camper shells.

### DETAILED DESCRIPTION OF THE INVENTION

The ladder rack cover is designed for the pick up truck that has a ladder rack mounted on the bed of the truck. The device is a fabric based tarp or cover attached to the ladder rack and bed of the pick up truck, creating a weather resistant shell for the protection of goods in the bed of the pick up.

The materials used in the construction of the ladder rack cover are fabric, webbing, clear vinyl, zippers, snaps, and Velcro. The fabric attaches around the legs of the ladder rack with zippers (can be attached rope, buttons, snaps, Velcro, etc,). At the top of the legs the fabric has Velcro collars which rap around the legs helping to attach the tarp and in creating a weather resistant seal. The base of the tarp attaches to the top of the bed of the truck using snaps (can be rope, buttons, Velcro, etc.). The top of the tarp is suspended below the top of the ladder rack by Velcro straps (can be hooks, buckled straps, etc.). The straps wrap around the crossbars, and cables that can be installed in place of missing crossbars, providing further support for the top of the tarp. The tarp has clear vinyl windows in both the front and back. These windows provide both visibility for the driver of the truck, and access as the windows can be unzipped. The sides of the tarp also have panels (can be windows if desired) that unzip to allow access to bed of the truck. For extra support there are cables run inside tarp from one leg of the ladder rack to the other on both sides of the tarp. The roof of the tarp can have tent poles installed to keep the rain and snow from pooling on the top of the tarp.

The ladder rack cover of the invention differs from prior inventions relating to truck bed covers as the ladder rack cover does not maintain or make claim to any solid support system or framing. The ladder rack cover is attached to the ladder rack and truck bead by Velcro strapping and snaps, protecting materials stored on the rack or in the bed of the truck from the elements

The ladder rack cover of the invention differs from prior inventions relating to truck bed storage racks or ladder racks as the ladder rack cover does not maintain or make claim to any solid framing, rack or material carrying capabilities. The ladder rack cover is a protective cover for materials on the related rack or truck.

### ILLLUSTRATIONS

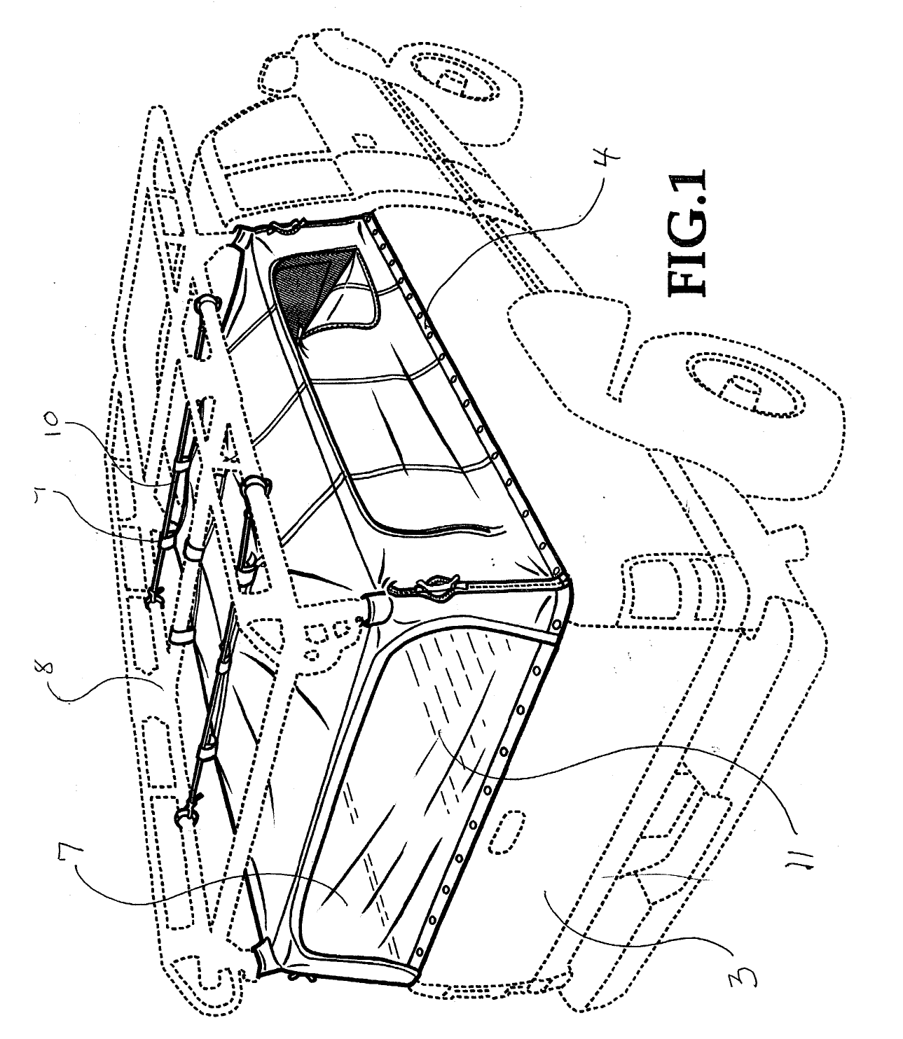

FIG. 1

A perspective view of the rear and right side of the device.

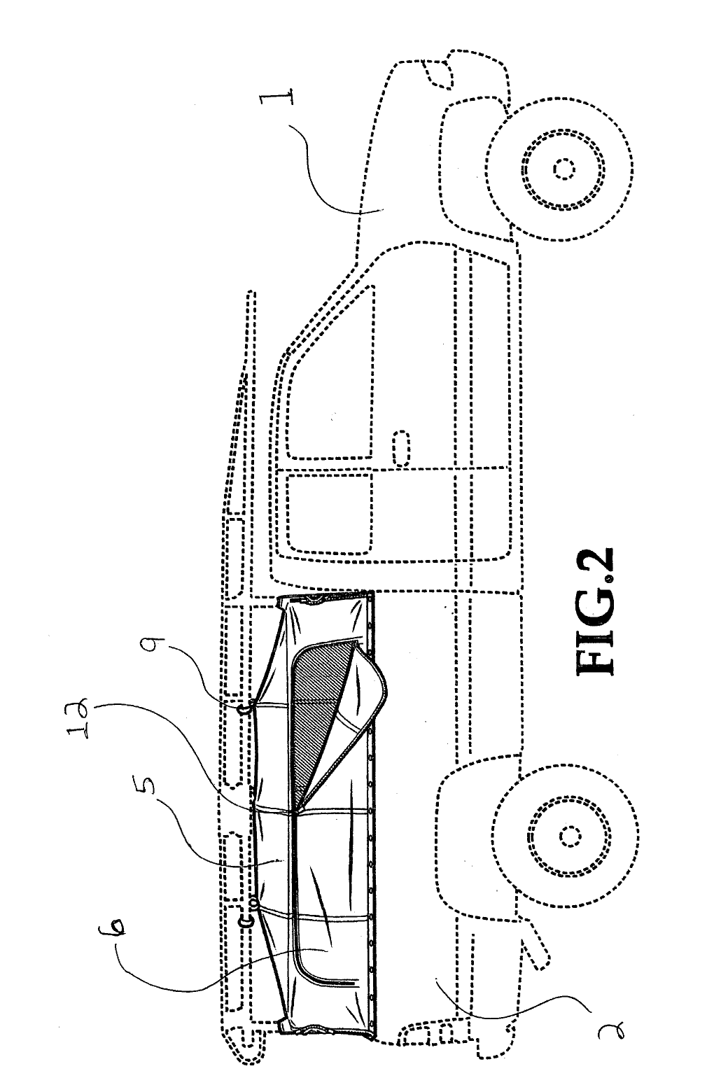

FIG. 2

A perspective view of the right side of the device.

### DESCRIPTION OF THE PREFERRED EMBODIMENT

Referring now to FIGS. 1 and 2, the pickup ladder rack cover of the present invention is used in conjunction with a standard pickup truck shown generally at numeral 1 for protecting cargo therein from weather and other external elements. The pickup truck usually has an open bed having upwardly projecting parallel sidewalls 2, a rear wall 3 which usually has a tailgate and an upwardly projecting front wall. Each side wall 2 has a substantially planar upper surface 4.

The device comprises a cover 5 preferably made with nylon, canvas or a similar durable weather resistant material. The cover 5 has a substantially rectangular configuration forming a box type enclosure when placed over the frame members having a pair of side walls 6, and a rear panel 7. Securing the cover member 5 to the ladder frame 8 members are Velcro straps 9 and cables 10.

The cover side and rear panels 11 has a substantially transparent window having four peripheral edges made from a shatter resistant material such as plastic or clear vinyl. Surrounding and substantially parallel to three of the peripheral edges of the window 11 is an access zipper 12 for selectively enclosing the cover and providing an access to the interior thereof.

We claim:

1. In combination with a pick up truck and ladder rack having an open bed with front and rear walls upwardly depending there from and first and second side walls upwardly depending from said open bed and perpendicularly disposed between said rear and front walls, each of said side walls having a top surface, said pickup truck further including a passenger cab having a rear wall which is immediately adjacent to said front wall, and a steel ladder or utility rack, having 4 upright support posts attached on said side walls, a ladder rack cover comprising of a cover overlaying said steel ladder and utility rack members, said cover having a pair of side walls, a rear panel, front panel and roof; said rear panel and side walls terminating at a lower edge with temporary attachments.

2. A ladder rack cover, according to claim 1, wherein clear vinyl windows are affixed to both sides and/or rear of the device

3. A ladder rack cover, according to claim 1, wherein the ladder rack cover can be rolled up and stored on the ladder rack when not in use.

4. A ladder rack cover, according to claim 1, wherein the sides or back of the cover can be temporarily affixed in an upward or open position to allow easy access to materials within the truck or on the ladder rack.
